(19) United States
(12) Patent Application Publication
(10) Pub. No.: US 2018/0022254 A1
(43) Pub. Date: Jan. 25, 2018

(54) SEAT

(71) Applicant: TACHI-S CO., LTD., Tokyo (JP)

(72) Inventors: Yoshihiko NISHINO, Tokyo (JP); Tsutomu FUJIKAKE, Tokyo (JP)

(21) Appl. No.: 15/546,521

(22) PCT Filed: Jan. 21, 2016
(86) PCT No.: PCT/JP2016/051703

§ 371 Date: Jul. 26, 2017

(30) Foreign Application Priority Data
Jan. 27, 2015 (JP) 2015-012867

(51) Int. Cl. B60N 2/58

(52) U.S. Cl. CPC B60N 2/5883

(57) ABSTRACT

Provided is a seat formed by coupling a surface cover of a seat section and a circumferential cover via a detachable first fastening part, wherein a cover for covering the first fastening part is provided at an end of the surface cover and a reduction part is formed on an end of the cover for covering the first fastening part so as to allow the first fastening part to be covered and prevented from being exposed to the outer surface of the first fastening part, thereby improving appearance quality, and the cover for covering the first fastening part is brought into close contact with the first fastening part without a gap by forming the reduction part on the end of the cover for covering the first fastening part and thus, the first fastening part can be covered in a reliable manner.

### TECHNICAL FIELD

The present invention relates to a seat capable of detachably attaching a surface cover relative to a circumferential cover.

### BACKGROUND ART

Heretofore, as prior art in the field like this, there is a seat described in Patent Literature 1 (Japanese Patent No. 5088126 B). In the seat described in this Patent Literature 1, a seat cushion is provided with slide fasteners at a rearward position and a circumferential surface extending from right and left side surfaces to a front surface of a seating surface, so that a removable seat cover for covering the outer surface of a seat base is engaged with the seat base.

### CITATION LIST

### Patent Literature

Patent Literature 1: Japanese Patent No. 5088126 B

### SUMMARY OF INVENTION

### Technical Problem

In the removable seat cover described in the Patent Literature 1, the slide fasteners being coupling portions are exposed to the outside, and thus, a problem arises in that the exposed slide fasteners arouse a sense of incongruity in design and are inferior in the quality of appearance.

Therefore, an object of the present invention is to provide a seat capable of enhancing the quality of appearance by covering a coupling portion of a removable seat cover.

### Solution to Problem

In order to solve the foregoing problem in the prior art, according to the present invention, in a seat which couples a surface cover and a circumferential cover for a seat section through a detachable first fastening portion, a cover for covering the first fastening portion is provided at an end portion of the surface cover, and a shrinkable portion is formed at an end portion of the cover for covering the first fastening portion.

Because the cover for covering the first fastening portion provided at the end portion of the surface cover is able to cover the first fastening portion, the first fastening portion can be prevented from being exposed to the outside, and thus, the quality of appearance can be improved. Because the shrinkable portion is formed at the end portion of the cover for covering the first fastening portion, the shrinkable portion residing at the end portion of the cover for covering the first fastening portion comes close contact without gaps with the first fastening portion being the coupling portion, and this prevents the end portion of the cover for covering the first fastening portion from being lifted up, so that the first fastening portion can be covered reliably.

Further, in order to solve the foregoing problem in the prior art, according to the present invention, in a seat equipped with a cushion material and a seat cover covering a surface of the cushion material, the seat cover is configured to have a first seat cover covering a surface of the cushion material and a second seat cover covering a circumferential side surface of the cushion material, wherein a first fastening member constituting one of a fastener is secured to an end portion of the first seat cover, wherein a second fastening member constituting the other of the fastener is secured to an end portion of the second seat cover, and wherein at the end portion of the first seat cover, a cover is further provided for covering an end portion of the second seat cover on a side where the second fastening member is secured, together with a portion fastened in the state that the first fastening member and the second fastening member constituting the fastener are fastened.

### Advantageous Effects of Invention

According to the present invention, the coupling portion of the removable seat cover is covered by the cover for covering the first fastening portion formed with the shrinkable portion at the end portion, and this reliably prevents the exposure of the coupling portion, so that the seat is improved in the quality of appearance.

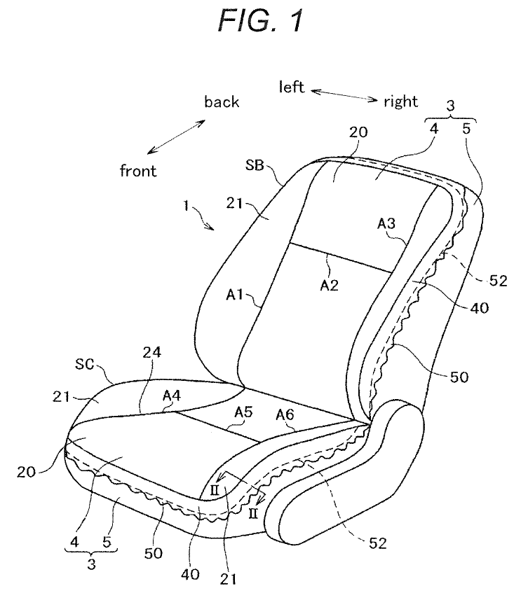

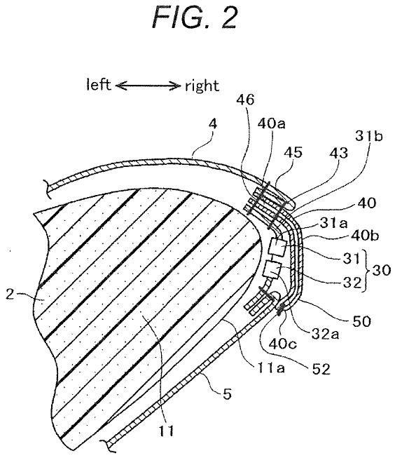

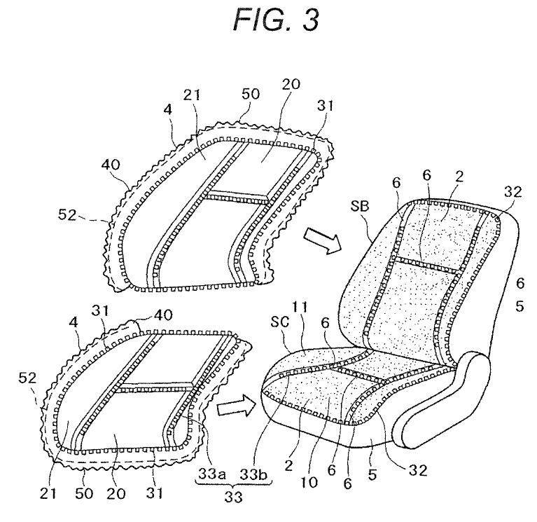

### BRIEF DESCRIPTION OF DRAWINGS

[FIG. 1] FIG. 1 is a perspective view showing a first embodiment of a seat according to the present invention.

[FIG. 2] FIG. 2 is a sectional view taken along the line II-II in FIG. 1.

[FIG. 3] FIG. 3 is a perspective view in a disassembled state of the seat.

### DESCRIPTION OF EMBODIMENT

The present invention resides in that in a seat which couples a surface cover and a circumferential cover of a seat section through a detachable first fastening portion, a cover for covering the first fastening portion is provided at an end portion of the surface cover, and a shrinkable portion is formed at an end portion of the cover for covering the first fastening portion. Thus, because the first fastening portion can be covered to be prevented from being exposed to the outside, the quality of appearance can be improved, and because the shrinkable portion is formed at the end portion of the cover for covering the first fastening portion, the shrinkable cover is enabled to come close contact with the first fastening portion without gaps, so that the first fastening portion can be covered reliably.

Hereinafter, a preferred embodiment of a seat according to the present invention will be described in detail with reference to the drawings.

A seat will be described in the case of an automotive seat.

### Embodiment

As shown in FIG. 1, an automotive seat 1 is equipped with a seat cushion (seat section) SC being movable back and forth on a floor panel and a seat back (seat section) SB capable of being reclined relative to the seat cushion SC. The seat cushion SC and the seat back SB are each covered with a surface skin 3 on the surface of a cushion material 2 made of foaming body. The surface skin 3 is composed of a surface cover 4 and a circumferential cover 5. The surface cover 4 and the circumferential cover 5 are made as separate members for respectively covering the cushion materials 2 of the seat cushion SC and the seat back SB.

In FIG. 1, the surface cover 4 and the circumferential cover 5 of the seat cushion SC and the surface cover 4 and the circumferential cover 5 of the seat back SB are respectively different in shape. However, those in the present invention are the same in function and thus, are expressed as the surface cover 4 and the circumferential cover 5 common to the seat cushion SC and the seat back SB.

In this seat 1, the seat cushion SC and the seat back SB are provided with linear hanging members A1 to A6. The hanging members A1 to A6 define the exterior of the seat 1 and at the same time, prevent the surface cover 4 from becoming loose and being dislocated.

As shown in FIG. 3, the hanging members A4, A5, A6 on the seat cushion SC are provided with a second fastening portion 33 for detachably coupling the cushion material 2 and the surface cover 4. The detachable second fastening portion 33 has a third fastening half portion 33b secured to the cushion material 2 within concavities 6 which extend on the cushion material 2 side in a front-back direction and a right-left direction along the hanging members A4 to A6. The second fastening portion 33 also has a fourth fastening half portion 33a which is provided on the surface cover 4 to be received within the concavities 6 and which is detachably coupled to the third fastening half portion 33b. The cushion material 2 of the seat cushion SC has a main cushion portion 10 for supporting the buttocks of a person seated and side cushion portions 11 for holding the femoral regions of the person seated in the lateral direction. The concavities 6 are formed in a predetermined depth along boundary portions between the main cushion portion 10 and the side cushion portions 11.

Incidentally, the hanging members A1 to A3 on the seat back SB are also the same in configuration as the hanging members A4 to A6 on the seat cushion SC.

Then, the surface cover 4 is formed by a main surface portion 20 placed on the main cushion portion 10 of the cushion material 2 and side surface portions 21 placed on the side cushion portions 11. The main surface portion 20 and the side surface portions 21 of the surface cover 4 are jointed at sewing parts 24. The fourth fastening half portion 33a is sewed at the sewing parts 24 on the cushion material 2 side and is fastened to the third fastening half portion within the concavities 6 formed in the cushion material 2. As shown in FIG. 2, the surface cover 4 and the circumferential cover 5 are detachably coupled by a first fastening portion 30 at outer lateral surfaces 11a of the side cushion portions 11. FIG. 2 is a sectional view taken along the line II-II in FIG. 1.

The detachable first fastening portion 30 has a first fastening half portion 31 provided to extend along the hem of the surface cover 4 and a second fastening half portion 32 provided to extend along the hem of the circumferential cover 5 and being able to be coupled detachably to the first fastening half portion 31. This first fastening portion 30 is constituted as a linear fastener, wherein teeth 31a called an element of the first fastening half portion 31 are meshed with teeth 32a called an element of the second fastening half portion 32 to couple the surface cover 4 to the circumferential cover 5.

Then, a cover 40 for covering the first fastening portion 30 is provided at an end portion of the surface cover 4 to extend along the right and left lateral surfaces and the front surface of the surface cover 4.

As shown in FIG. 2, this cover 40 for covering the first fastening portion is tuned up to be double folded and, on an opening portion 40a side, is sewed at a first sewing part 43 with the surface cover 4, the opening portion 40a and a base material 31b of the first fastening half portion 31 each put on another. Subsequently, the surface cover 4 is turned up at the first sewing part 43 having been sewed like this and is folded double at an end portion 45. In this state, a sewing is performed at a second sewing part 46 in parallel to the first sewing part 43, and thus, the cover 40 for covering the first fastening portion is secured to the surface cover 4 and the base material 31b of the first fastening half portion 31.

Like this, by sewing the opening portion 40a of the cover 40 for covering the first fastening portion with the end portion 45 of the surface cover 4 at the first sewing part 43 and the second sewing part 46 being in parallel, the turned-up portion 40b of the cover 40 for covering the first fastening portion become a tendency to hang down in a direction toward the first fastening half portion 31 of the first fastening portion 30 and thus, becomes easy to cover the first fastening portion 30.

Furthermore, a shrinkable portion 50 is formed at a lower end portion 40c on the turned-up portion 40b side of the cover 40 for covering the first fastening portion. This shrinkable portion 50 is formed by shirring-sewing. The shirring-sewing sews the lower end portion 40c on the turned-up portion 40b side of the cover 40 for covering the first fastening portion by a string 52 in the longitudinal direction to make shrinkable the lower end portion 40c on the turned-up portion 40b side of the cover 40 for covering the first fastening portion.

By being made to be shrinkable, the lower end portion 40c of the cover 40 for covering the first fastening portion is brought into close contact with the first fastening portion 30 side, and thus, the cover 40 for covering the first fastening portion is restrained from opening at the lower end portion 40c, whereby the first fastening portion 30 can be covered reliably.

Further, the lower end portion 40c of the cover 40 for covering the first fastening portion is held shrunken only, and thus, when the first fastening portion 30 is fastened, the cover 40 for covering the first fastening portion can be turned up easily. This enables the fastening operation of the first fastening portion 30 to be carried out easily and also enables the cover 40 for covering the first fastening portion to be easily returned to cover the first fastening portion 30.

According to the seat like this, in order to cover the cushion material 2 of the seat cushion SC with the surface cover 4, the second fastening portion 33 for the hanging member A5 is fastened first, then the second fastening portion 33 for the hanging members A4, A6 is fastened, and lastly, the first fastening portion 30 is fastened. Thus, as shown in FIG. 1, the surface cover 4 can be attached to the cushion material 2 and the circumferential cover 5, and the cover 40 for covering the first fastening portion becomes the state of covering the first fastening portion 30 and makes the shrinkable portion 50 contact closely with the first fastening portion 30. Therefore, it does not occur that the first fastening portion 30 is exposed to the outside, and hence, the quality of appearance can be improved.

Furthermore, in changing the surface cover 4, since the cover 40 for covering the first fastening portion of the surface cover 4 is held in close contact at the shrinkable portion 50 with the first fastening portion 30, the fastened state of the first fastening portion 30 is released in a state that the cover 40 of the surface cover 4 is turned up. Then, when the fastened state of the second fastening portions 33 of the hanging members A4, A5 and A6 are released in the order, the surface cover 4 can be removed as shown in FIG. 3, whereby the removal operation of the surface cover 4 can be done.

With respect to the seat back SB, the configuration is the same as that of the foregoing seat cushion SC. Thus, the same reference sings used in the foregoing description are given, and the description will be omitted.

In the foregoing description, the shirring-sewing has been described as the formation of the shrinkable portion 50. Without being limited to this, other sewing methods may be used to form the shrinkable portion.

Further, although the foregoing embodiment has been described in the case of an automotive seat, the seat according to the preset invention can be used as seats for aircrafts, electric trains, buses and passenger ships. Further, another application is possible in covering fasteners of a hood in a convertible. Although in the foregoing, description has been made in the case of a removable seat cover, it is needless to say that the present invention is not limited to this example.

### INDUSTRIAL APPLICABILITY

A seat according to the present invention can be used as automotive seats and seats for aircrafts, electric trains, buses and passenger ships.

### REFERENCE SIGNS LIST

1: seat

2: cushion material

3: surface skin

4: surface cover

5: circumferential cover

30: first fastening portion

31: first fastening half portion

32: second fastening half portion

33: second fastening portion

A1 to A6: hanging members

SB: seat back (seat section)

SC: seat cushion (seat section)

40: cover for covering the first fastening portion

50: shrinkable portion

1. A seat which couples a surface cover and a circumferential cover for a seat section through a detachable first fastening portion,
wherein a cover for covering the first fastening portion is provided at an end portion of the surface cover, and wherein a shrinkable portion is formed at an end portion of the cover for covering the first fastening portion.

2. The seat according to claim 1, wherein the shrinkable portion is formed by shirring-sewing.

3. The seat according to claim 1, wherein the seat section is a seat cushion, and wherein the cover for covering the first fastening portion is provided on the surface cover at right and left lateral surfaces and a front surface of the seat cushion.

4. The seat according to claim 1, wherein the seat section is a seat back, and wherein the cover for covering the first fastening portion is provided on the surface cover at right and left lateral surfaces and an upper surface of the seat back.

5. A seat comprising a cushion material and a seat cover covering a surface of the cushion material; wherein:
the seat cover has a first seat cover covering a surface of the cushion material and a second seat cover covering a surface of a circumferential side of the cushion material;
a first fastening member constituting one part of a fastener is secured to an end portion of the first seat cover;
a second fastening member constituting another part of the fastener is secured to an end portion of the second seat cover; and
at the end portion of the first seat cover, in a state that the first fastening member and the second fastening member constituting the fastener are fastened, a cover for covering an end portion of the second seat cover to which the second fastening member is fixed is further provided.

6. The seat according to claim 5, wherein the end portion of the first seat cover, the first fastening member and the cover for covering the first fastening portion are sewed to be secured.

7. The seat according to claim 5, wherein shirring-sewing is performed at an end portion of the cover for covering the first fastening portion on an opposite side to a side where the cover for covering the first fastening portion is sewed with the first seat cover.
